(19) United States
(12) Patent Application Publication
(10) Pub. No.: US 2023/0055410 A1
(43) Pub. Date: Feb. 23, 2023

(54) METHOD FOR MANUFACTURING A MULTILAYER ALUMINIUM ALLOY STRIP OR SHEET FOR MAKING BRAZED HEAT EXCHANGERS

(71) Applicant: CONSTELLIUM NEUF-BRISACH, Biesheim (FR)

(72) Inventors: Benoit BRUN, COLMAR (FR); Didier MAURIN, LA BUISSE (FR); Armelle DANIELOU, Les Echelles (FR)

(21) Appl. No.: 17/790,109

(22) PCT Filed: Jan. 5, 2021
(86) PCT No.: PCT/FR2021/050009

§ 371 Date: Jun. 29, 2022

(30) Foreign Application Priority Data
Jan. 7, 2020 (FR) FR2000105

(51) Int. Cl. C22F 1/04; B32B 15/01; C22C 21/00; B23K 35/28; B23K 35/02

(52) U.S. Cl. CPC C22F 1/04; B32B 15/016; C22C 21/00; B23K 35/286; B23K 35/0238; B23K 2101/14

(57) ABSTRACT

Process for manufacturing a multilayer strip or sheet, comprising the successive steps of:
casting a brazing aluminum alloy in the form of a casting slab;
sawing the casting slab to obtain sawn brazing alloy layers;
bonding a core aluminum alloy layer with at least one sawn brazing aluminum alloy layer to obtain a multilayer assembly;
preheating the multilayer assembly;
hot-rolling the multilayer assembly to obtain a multilayer strip or sheet, the first hot-rolling pass inducing a reduction in thickness of the multilayer assembly greater than or equal to 0.5% of the thickness of the multilayer assembly before said hot-rolling pass.

### TECHNICAL FIELD

The present disclosure relates to the field of strips or sheets (of thickness generally from 0.05 to 3.5 mm, preferably from 0.15 to 2.5 mm) used for heat exchangers made of aluminum alloy, and preferably with a core alloy made of aluminum-manganese alloy (3xxx series according to the nomenclature of the Aluminum Association), cladded on one or two faces with a brazing alloy layer, preferably of aluminum-silicon alloy (4xxx series according to the nomenclature of the Aluminum Association), obtained by sawing and optionally with an intermediate alloy, generally placed between the core and the brazing alloy. These strips or sheets are particularly intended for manufacturing elements, such as tubes, plates and headers, used in heat exchangers assembled by brazing. These exchangers are particularly found in automobile engine cooling and dashboard air conditioning systems. Aluminum alloy brazing techniques are described for example in the article by J. C. Kucza, A. Uhry and J. C. Goussain “Le brasage fort de I'aluminium et ses alliages,” published in Soudage et Techniques Connexes, November-December 1991, pp. 18-29. The strips or sheets according to the invention can particularly be used in brazing techniques in controlled atmosphere cooling (CAB) furnaces with a flux for example such as NOCOLOK® or with no flux, or in vacuum brazing furnaces.

### PRIOR ART

The properties required for the aluminum alloy strips or sheets used for manufacturing brazed exchangers are in particular a sufficient formability for easy forming of tubes, plates and headers, before brazing, a good brazability, a high mechanical strength after brazing, and a high corrosion resistance after brazing. Obviously, it is important that the alloys chosen are easy to cast and roll and/or co-roll and that the manufacturing cost of the strips or sheets is compatible with automobile industry requirements. During the step of co-rolling the multilayer strips or sheets, it is important to have good cohesion between the different core alloy, brazing alloy and optionally intermediate alloy layers without there being any formations of blisters visible to the naked eye on the strip or sheet surface.

From the European patents EP 1 200 253 B2 held by Hydro, EP 1 992 441 B1 or EP 2 428 306 B1, processes for manufacturing a composite aluminum alloy material are known wherein a covering alloy layer is cladded on at least one side with a core layer and wherein the cladded core layer undergoes several rolling passes. In these patents, the covering layer is produced by sawing. The documents EP 1 992 441 B1 and EP 2 428 306 B1 disclose the need for high requirements concerning the surface of the sawn covering sheets to obtain “an optimal bond between the core layer and the covering layer”. The covering alloy layers then necessarily undergo a step of smoothing the surface prior to the rolling step and/or have a roughness Ra between 0.05 and 1.0 μm. It should be noted that the measurement filters are not specified.

### SUMMARY

The present disclosure improves the situation.

A process is proposed for manufacturing a multilayer strip or sheet, comprising a core aluminum alloy layer cladded, on one or both main faces, with a brazing aluminum alloy layer, characterized in that it comprises the successive steps of:

a. casting a brazing aluminum alloy in the form of a casting slab, having preferably a thickness from 400 to 700 mm, more preferably from 500 to 650 mm; preferably a width from 1500 to 2000 mm, preferably from 1600 to 1850 mm; preferably a length from 2500 to 6000 mm, preferably 3000 to 4500 mm;

b. optionally, stress-relieving the casting slab by thermal treatment;

c. sawing the casting slab to obtain brazing alloy layers sawn along a plane parallel with the plane of at least one of the main faces of said casting slab;

d. bonding a core aluminum alloy layer, which can be optionally homogenized, with at least one sawn brazing aluminum alloy layer, to obtain a multilayer assembly;

e. preheating the multilayer assembly, preferably at a temperature from 440 to 540° C., preferably with a holding time at the maximum temperature of less than 30 hours, preferably less than 24 hours, more preferably less than 20 hours, preferably with a temperature rise time of less than 24 hours, preferably less than 20 hours, more preferably less than 15 hours;

f. hot-rolling the multilayer assembly to obtain a multilayer strip or sheet, the first hot-rolling pass inducing a reduction in thickness of the multilayer assembly greater than or equal to 0.5% of the thickness of the multilayer assembly before said hot-rolling pass; the thickness of the multilayer strip or sheet obtained after all the hot-rolling passes being preferably from 2 to 5.5 mm;

g. optionally, cold-rolling the multilayer strip or sheet, to the desired thickness, the thickness of the strip or sheet after cold rolling being preferably from 0.15 to 3 mm and

h. optionally annealing, preferably at a temperature from 230 to 450° C., preferably with holding at the maximum temperature for 1 minute to 15 hours, preferably for 1 minute to 5 hours.

According to another aspect, a strip or sheet is proposed, intended for manufacturing brazed heat exchangers, obtained according to the process of the present invention wherein the brazing aluminum alloy casting slab:
does not undergo, prior to the sawing step, homogenizing; and
does not undergo, prior to the sawing step, stress relief, or undergoes, prior to the sawing step, stress relief at a temperature less than 400° C., preferably less than 380° C., more preferably less than 355° C. and even more preferably less than or equal to 350° C., preferably for a duration less than 10 h, more preferably less than 5 h;
the strip or sheet at final thickness before brazing having at least one of the brazing layers which is obtained by sawing and which has a silicon particle size of surface area greater than or equal to 0.011 μm² (measured in the L-TC plane) such that the average equivalent diameter of these particles is less than 1.6 μm, preferably less than 1.5 μm, preferably less than 1.4 μm.

According to another aspect, a heat exchanger made at least partially from a strip or sheet obtained according to the process of the invention is proposed.

According to another aspect, the use is proposed of a strip or sheet according to the present invention, for manufacturing a heat exchanger, said strip or sheet having an enhanced corrosion resistance without degrading the mechanical strength or brazability in relation to a strip or sheet having an identical configuration but comprising at least one brazing layer obtained by rolling. The features described in the following paragraphs can, optionally, be implemented. They can be implemented independently of one another or in combination with one another:

Preferably, the brazing alloy layer(s) represent from 4 to 15%, preferably from 4 and 12% in thickness of the total thickness of the multilayer assembly before any rolling step.

Preferably, the brazing aluminum alloy casting slab undergoes, prior to the sawing step, stress relief, preferably thermal, at a temperature less than 400° C., preferably less than 380° C., more preferably less than 355° C. and even more preferably less than or equal to 350° C., advantageously for a duration less than 24 hours, preferably less than 10 hours and more preferably less than 3 hours.

According to an alternative embodiment, the brazing aluminum alloy casting slab does not undergo, prior to the sawing step, stress relief, for example thermal.

Preferably, the multilayer strip or sheet further comprises at least one intermediate aluminum alloy layer placed between the core aluminum alloy layer and a layer of a brazing aluminum alloy.

Preferably, the core alloy layer undergoes a homogenizing step prior to the cladding step, preferably at a temperature from 560 to 630° C., preferably for 10 minutes to 18 hours.

According to an alternative embodiment, the core alloy layer does not undergo a homogenizing step prior to the cladding step.

Preferably, the brazing alloy layer is prepared from 4xxx alloy, preferably from an alloy chosen from the AA4045, AA4343, AA4004 and AA4104 alloys, more preferably from an alloy (for example 4xxx, AA4045, AA4343, AA4004 and/or AA4104) comprising a quantity of Zn less than 0.05% by mass.

Preferably, the brazing alloy layer has, after sawing and before rolling, a surface roughness as defined in the standard NF EN ISO 4287 of December 1998:
Ra less than 14 μm, preferably less than 11 μm, preferably less than 10 μm and preferably greater than 1 μm, preferably greater than 2 μm, preferably greater than 5 μm, measured with a Gaussian filter of 0.8 mm wavelength in the direction perpendicular to the saw marks; and/or
Ra less than 50 μm, preferably less than 40 μm, more preferably less than 32 μm, even more preferably less than 20 μm, and preferably greater than 3 μm, preferably greater than 5 μm, preferably greater than 15 μm, measured with a Gaussian filter of 8 mm wavelength in the direction perpendicular to the saw marks; and/or
Rt less than 250 μm, preferably less than 200 μm, preferably less than 180 μm and preferably greater than 25 μm, preferably greater than 30 μm, preferably greater than 50 μm, measured with a Gaussian filter of 0.8 mm wavelength in the direction perpendicular to the saw marks; and/or
Rt less than 400 μm, preferably less than 350 μm, more preferably less than 280 μm, and preferably greater than 15 μm, preferably greater than 35 μm, measured with a Gaussian filter of 8 mm wavelength in the direction perpendicular to the saw marks.

Preferably, the core alloy layer comprises, in mass percentages:
Si: at most 0.8%, preferably at most 0.6%, more preferably at most 0.5%; and even more preferably at most 0.25%;
Fe: at most 0.5%, preferably at most 0.4%, more preferably at most 0.3%;
Cu: from 0.20 to 1.2%, preferably from 0.25 to 1.1%, more preferably from 0.3 to 1.0%, even more preferably from 0.5 to 0.8%, even more preferably from 0.55 to 0.75%;
Mn: from 0.8 to 2.2%, preferably from 0.9 to 2.1%, more preferably from 1.0 to 2.0%, more preferably from 1.0 to 1.5%, even more preferably from 1.25 to 1.45%;
Mg: at most 0.6%, preferably at most 0.35%, more preferably at most 0.20%, even more preferably less than 0.05%;
Zn: at most 0.30%, preferably at most 0.25%, more preferably at most 0.20%, and even more preferably less than 0.05%;
Ti: at most 0.30%, preferably at most 0.25%, more preferably at most 0.20%, even more preferably at most 0.14%, and even more preferably at most 0.12%; preferably at least 0.05%;
remainder aluminum and impurities.

### BRIEF DESCRIPTION OF THE FIGURES

Further features, details and advantages will emerge on reading the detailed description hereinafter and on studying the appended figures.

FIG. 1 is a photo showing the sample used for the brazing tests of the examples.

FIG. 2 is a diagram describing the perforation analysis during the corrosion resistance test of the examples.

### DESCRIPTION OF THE EMBODIMENTS

In the context of the present description, the following definitions should be specified. Unless specified otherwise, all the indications concerning the chemical composition of the alloys are expressed as a percentage by weight based on the weight of the alloy. The alloys are designated in accordance with the rules of the Aluminum Association. Temper definitions are stated in the European standard EN 515.

In the present application, the terms “controlled atmosphere” mean an atmosphere having a majority gas, for example nitrogen or argon, and having a limited quantity of O2, preferably comprising less than 150 ppm, more preferably less than 100 ppm, even more preferably less than 50 ppm, and even more preferably less than 20 ppm of oxygen.

According to an embodiment, the present invention relates to a process for manufacturing a multilayer strip of sheet. The multilayer strip of sheet comprises a core aluminum alloy layer cladded, on one or both of the main faces thereof, with a brazing aluminum alloy layer, preferably 4xxx type and optionally comprises one or two intermediate aluminum alloy layers between the core aluminum alloy layer and the brazing aluminum alloy layer. After bonding the different layers and before rolling, the term multilayer assembly is used. After rolling the multilayer assembly, a multilayer strip or sheet is obtained.

### Multilayer Strip or Sheet

The multilayer strip or sheet is obtained by hot- and optionally cold-rolling the multilayer assembly. The total thickness of the strip or sheet is advantageously from 0.05 to 3.5 mm, preferably from 0.15 to 2.5 mm, more preferably from 0.18 to 1 mm.

The strip or sheet according to the present invention can have a configuration with several layers, and in particular with 2, 3, 4 or 5 layers.

The configuration with two layers comprises a core cladded with a brazing layer on a single face.

The configuration with three layers comprises:
either a core layer cladded on both faces thereof with a brazing layer;
or a core layer cladded on only one face with an intermediate layer and a brazing layer;
or a core layer cladded on a first face with a brazing layer and on the other face with a protective layer for enhancing corrosion resistance, for example made of 1xxx, 3xxx or 7xxx type alloy.

The configuration with four layers comprises:
either a core layer cladded on a first face with an intermediate layer and a brazing layer and on the other face with a brazing layer;
or a core layer cladded on a first face with an intermediate layer and a brazing layer and on the other face with a protective layer for enhancing corrosion resistance, for example made of 1xxx, 3xxx or 7xxx type alloy. Optionally, the protective layer can be obtained by sawing.

The configuration with five layers comprises a core layer cladded on one of the two faces thereof with an intermediate layer and a brazing layer.

### Core Aluminum Alloy

According to an embodiment, the core aluminum alloy layer is made of 3xxx type alloy.

According to an embodiment, the core layer has been obtained by sawing.

According to an embodiment, the core aluminum alloy layer comprises, as a percentage by weight:
Si: at most 0.8%, preferably at most 0.6%, more preferably at most 0.5%; and even more preferably at most 0.25%;
Fe: at most 0.5%, preferably at most 0.4%, more preferably at most 0.3%;
Cu: from 0.20 to 1.2%, preferably from 0.25 to 1.1%, more preferably from 0.3 to 1.0%, even more preferably from 0.5 to 0.8%, even more preferably from 0.55 to 0.75%;
Mn: from 0.8 to 2.2%, preferably from 0.9 to 2.1%, more preferably from 1.0 to 2.0%, more preferably from 1.0 to 1.5%, even more preferably from 1.25 to 1.45%;
Mg: at most 0.6%, preferably at most 0.35%, more preferably at most 0.20%, even more preferably less than 0.05%;
Zn: at most 0.30%, preferably at most 0.25%, more preferably at most 0.20%, and even more preferably less than 0.05%;
Ti: at most 0.30%, preferably at most 0.25%, more preferably at most 0.20%, even more preferably at most 0.14%, and even more preferably at most 0.12%; preferably at least 0.05%;
remainder aluminum and impurities.

The composition limits of the base alloy used as a core can be justified as follows. A limited iron content is favorable for corrosion resistance and for formability, but it is not necessary to go down to very low values (for example <0.10%) which would result in high production costs. Copper is a hardening element which contributes to mechanical strength, but above 1.2%, coarse intermetallic compounds can be formed on casting, which are detrimental to the homogeneity of the metal and form corrosion initiation sites, or slab cracks during casting. Manganese contributes to mechanical strength. A limited addition of zinc can have a beneficial effect on corrosion resistance, by modifying the electrochemical potentials, particularly for alloys with higher copper concentrations. However, it must remain below 0.3% to prevent an excessively high susceptibility to generalized corrosion.

### Brazing Aluminum Alloy

According to an advantageous embodiment, the brazing alloy layer(s) represent from 4 to 15%, preferably from 4 and 12% in thickness of the total thickness of the multilayer assembly before rolling.

According to a preferred embodiment, the brazing alloy layer is prepared from an alloy of the 4xxx family, preferably from an alloy chosen from the AA4045, AA4343, AA4004 and AA4104 alloys, more preferably from an alloy (for example 4xxx, AA4045, AA4343, AA4004 and/or AA4104) comprising a quantity of Zn less than 0.05% by mass.

### Aluminum Alloy of the Intermediate Layer

According to an embodiment, the multilayer strip or sheet further comprises at least one intermediate aluminum alloy layer placed between the core aluminum alloy layer and a layer of brazing aluminum alloy.

According to an embodiment, the intermediate layer has been obtained by sawing.

Preferably, the intermediate aluminum alloy of the strip or sheet according to the present invention is 3xxx or 1xxx type, for example AA3003, AA3207 or AA1050, more preferably 3xxx type, for example AA3003 or AA3207.

By way of illustration, the intermediate aluminum alloy of the strip or sheet according to the present invention can comprise (% by mass):
AA3003: less than 0.6% Si; less than 0.7% Fe; from 0.05 to 0.20% Cu; from 1.0 to 1.5% Mn; less than 0.10% Zn, impurities less than 0.05% each and less than 0.15% in total; remainder Al; or
AA3207: less than 0.30% Si; less than 0.45% Fe; less than 0.10% Cu; from 0.40 to 0.8% Mn; less than 0.10% Mg; less than 0.10% Zn, impurities less than 0.05% each and less than 0.15% in total; remainder Al; or
AA1050: less than 0.25% Si; less than 0.40% Fe; less than 0.05% Cu; less than 0.05% Mn; less than 0.05% Mg; less than 0.05% Zn, less than 0.03% Ti; less than 0.05% V; impurities less than 0.03% each; at least 99.50% Al.

Preferably, the intermediate aluminum alloy of the strip or sheet according to the present invention comprises (% by mass): Si<0.25%, preferably <0.18%;

Fe<0.2%; Cu<0.1%; Mn from 0.6 to 0.8%; Mg<0.02%; other elements <0.05% each and <0.15% in total, remainder aluminum.

### Process for Manufacturing a Multilayer Strip or Sheet

The process according to the present invention comprises the successive steps of:

a. casting a brazing alloy in the form of a casting slab, having preferably a thickness from 400 to 700 mm, more preferably from 500 to 650 mm; preferably a width from 1500 to 2000 mm, preferably from 1600 to 1850 mm; preferably a length from 2500 to 6000 mm, preferably 3000 to 4500 mm;

b. optionally, stress-relieving the casting slab by thermal treatment;

c. sawing the casting slab to obtain brazing alloy layers sawn along a plane parallel with the plane of at least one of the main faces of said casting slab;

d. bonding a core aluminum alloy layer, which can be optionally homogenized, with at least one sawn brazing aluminum alloy layer to obtain a multilayer assembly;

e. preheating the multilayer assembly, preferably at a temperature from 440 to 540° C., preferably with a holding time at the maximum temperature of less than 30 hours, preferably less than 24 hours, more preferably less than 20 hours, preferably with a temperature rise time of less than 24 hours, preferably less than 20 hours, more preferably less than 15 hours;

f. hot-rolling the multilayer assembly to obtain a multilayer strip or sheet, the first hot-rolling pass inducing a reduction in thickness of the multilayer assembly greater than or equal to 0.5% of the thickness of the multilayer assembly before said hot-rolling pass; the thickness of the multilayer strip or sheet after all the hot-rolling passes being preferably from 2 to 5.5 mm;

g. optionally, cold-rolling the multilayer strip or sheet, to the desired thickness, the thickness of the strip or sheet after cold rolling being preferably from 0.15 to 3 mm and

h. optionally annealing, preferably at a temperature from 230 to 450° C., preferably with holding at the maximum temperature for 1 minute to 15 hours, preferably for 1 minute to 5 hours.

Before the bonding of step d), the core alloy is generally cast in the form of a casting slab. This slab is generally scalped on at least the two main faces thereof.

According to the present invention, the brazing aluminum alloy layer is cast and then sawn along a plane parallel with the plane of at least one of the main faces of said brazing alloy layer. The sawing step is performed on one, preferably both of the main faces of the brazing aluminum alloy layer. Reducing the thickness of the brazing layer by sawing rather than by rolling has numerous advantages. In particular, the manufacturing process is simplified and has a lower manufacturing cost. However, while such a sawing step is known from the prior art, it is in no way specified in the prior art how to prevent the formation of visible blisters on the surface of the final strip or sheet. Moreover, according to certain prior art documents described above, this sawing step is necessarily followed by a surface preparation step, in particular a polishing step in order to reduce the surface roughness of the layer and enable good cohesion of the layers of the multilayer strip or sheet during the co-rolling step. Cleaning after sawing does not represent a surface preparation step and is therefore not excluded from the present invention. Very surprisingly, the process according to the present invention makes it possible to avoid such a surface preparation step of the sawn brazing layer and in particular a polishing step. Thus, following the sawing step, the brazing alloy layer can have, according to a roughness measurement after sawing and before rolling, a maximum deviation between peaks and troughs over a length of 150 mm in the direction perpendicular to the saw marks of less than 0.55 mm and preferably less than 0.3 mm.

According to an embodiment compatible with the above, the brazing alloy layer can have, after sawing and before rolling, a surface roughness as defined in the standard NF EN ISO 4287 of December 1998:
Ra less than 14 μm, preferably less than 11 μm, preferably less than 10 μm and preferably greater than 1 μm, preferably greater than 2 μm, preferably greater than 5 μm, measured with a Gaussian filter of 0.8 mm wavelength in the direction perpendicular to the saw marks; and/or
Ra less than 50 μm, preferably less than 40 μm, more preferably less than 32 μm, and more preferably less than 20 μm, and preferably greater than 3 μm, preferably greater than 5 μm, preferably greater than 15 μm, measured with a Gaussian filter of 8 mm wavelength in the direction perpendicular to the saw marks; and/or
Rt less than 250 μm, preferably less than 200 μm, preferably less than 180 μm and preferably greater than 25 μm, preferably greater than 30 μm, preferably greater than 50 μm, measured with a Gaussian filter of 0.8 mm wavelength in the direction perpendicular to the saw marks; and/or
Rt less than 400 μm, preferably less than 350 μm, more preferably less than 280 μm, and preferably greater than 15 μm, preferably greater than 35 μm, measured with a Gaussian filter of 8 mm wavelength in the direction perpendicular to the saw marks.

The roughness profile after sawing and before rolling of the brazing alloy layers was measured with a perthometer, over a distance of 150 mm, in the direction perpendicular to the saw marks. The start and end of the profile were removed (12.5 mm on either side). The profile was corrected with a second-degree polynomial. The maximum-minimum deviation between peaks and troughs was deduced therefrom. The values of Ra and Rt as defined in the standard NF EN ISO 4287 of December 1998 were then calculated with two Gaussian filters of respective wavelength 0.8 mm and 8 mm over a distance of 125 mm. The roughness Ra (in μm) is the arithmetic mean of the profile. The roughness Rt (in μm) is the total height of the roughness profile.

The sawn brazing alloy layer is then cladded on the core aluminum alloy layer to obtain a multilayer assembly. Optionally, at least one intermediate aluminum alloy layer is placed between the brazing alloy layer and the core alloy layer.

According to an advantageous embodiment, the brazing aluminum alloy casting slab undergoes, prior to the sawing step, stress relief, preferably thermal, at a temperature less than 400° C., preferably less than 380° C., more preferably less than 355° C. and even more preferably less than or equal to 350° C., advantageously for a duration less than 24 hours, preferably less than 10 hours and more preferably less than 3 hours. According to another embodiment, the casting slab, prior to the sawing step, does not, on the other hand, undergo stress relief.

According to an embodiment, the core alloy layer undergoes a homogenizing step prior to the cladding step, preferably at a temperature from 560 to 630° C., preferably for 10 minutes to 18 hours. According to another embodiment, the brazing aluminum alloy casting slab preferably does not undergo a homogenizing step prior to the sawing step. Similarly, according to another embodiment, the brazing alloy layer does not undergo a homogenizing step prior to the cladding step.

The multilayer assembly comprising a sawn brazing alloy layer undergoes a specific hot-rolling step making it possible to avoid the surface preparation step of the sawn brazing alloy layer. Thus, the first hot-rolling pass of the multilayer assembly induces a reduction in thickness of the multilayer assembly greater than or equal to 0.5% of the thickness of the multilayer assembly before said hot-rolling pass. Surprisingly, such a hot-rolling step enables good cohesion between the different core alloy, brazing alloy and optionally intermediate alloy layers without there being any visible blister formations on the surface of the strip or sheet, even when the brazing alloy layer(s) have not undergone surface preparation such as a polishing prior to cladding.

Preferably, the total thickness of the strip or sheet after all the hot-rolling passes is preferably from 2 to 5.5 mm

Optionally, the multilayer strip or sheet undergoes a cold-rolling step after the hot-rolling step, in order to obtain a strip or sheet of desired final thickness. The thickness of the strip or sheet after cold rolling is preferably from 0.15 to 3 mm.

According to an embodiment, the multilayer strip or sheet can then undergo an annealing step, preferably at a temperature of 230 to 450° C. Advantageously, the maximum annealing temperature is maintained for 1 minute to 15 hours, preferably for 1 minute to 5 hours.

The strip or sheet according to the invention can be used for manufacturing different parts of a heat exchanger, for example tubes, plates, headers, etc. More specifically, the strip or sheet obtained according to the present invention is intended for manufacturing brazed heat exchangers.

The strip or sheet obtained according to the process of the present invention advantageously comprises at least one brazing layer obtained by sawing and of which the average equivalent diameter of silicon particles of surface area greater than or equal to 0.011 μm² (measured in the L-TC plane) is less than 1.6 μm, preferably less than 1.5 μm, preferably less than 1.4 μm. The average equivalent diameter of silicon particles is obtained by analyzing images from photographs made with an optical microscope with a magnification factor of ×50 in [(rolling direction)×(short transverse direction)] plane. It should be noted that the short transverse direction corresponds to the thickness of the strip or sheet. The minimum particle surface area analyzed is 0.011 μm², measured in the L-TC plane. Based on the total surface area of each particle, an equivalent diameter is defined, which corresponds to that of circular particle of the same surface area. An average is then calculated with all the equivalent diameters determined. The present inventors demonstrated in particular a non-degradation, or an enhancement of the corrosion resistance of the strips or sheet comprising such brazing layers.

The invention also relates to a heat exchanger made at least partially from a strip or sheet obtained according to the present invention.

The invention also relates to the use of a strip or sheet according to the present invention, for manufacturing a heat exchanger, said strip or sheet having an enhanced corrosion resistance without degrading the mechanical strength or brazability in relation to a strip or sheet having an identical configuration but comprising at least one brazing layer obtained by rolling.

The strips or sheets according to the present invention can be used in the manufacture of radiators, particularly for automobiles, such as engine cooling radiators, oil radiators, heating radiators and boost air coolers, as well as air-conditioning systems (particularly evaporators and condensers), and the cooling of batteries in the case of electric vehicles.

### EXAMPLES

### Example 1

Industrial tests were conducted as follows:

Two AA4045 brazing alloys (see the compositions in Table 1 hereinafter, in mass percentages) were cast in the form of a 560 mm thick slab. The AA4045 alloy slabs were sawn on both faces along a plane parallel with one of the main faces of the slab, in layers 64 mm thick each. Prior to the sawing step, the slabs of tests 4 to 6 did not undergo stress relief whereas those of tests 1 to 3 underwent stress relief by heating at 350° C. for 2 h.

TABLE 1

| | AA4045-1 | AA4045-2 | Alloy A | Alloy B | Alloy C |
|---|---|---|---|---|---|
| Si | 9.8 | 9.7 | 0.2 | 0.2 | 0.2 |
| Fe | 0.25 | 0.17 | 0.14 | 0.15 | 0.12 |
| Cu | 0.01 | 0.01 | 0.65 | 0.77 | 0.63 |
| Mn | 0.02 | 0.02 | 1.37 | 1.36 | 1.31 |
| Mg | 0.001 | 0.002 | — | 0.16 | — |
| Cr | — | 0.001 | — | — | — |
| Ni | 0.01 | 0.005 | — | — | — |
| Zn | — | 0.004 | — | — | — |
| Ti | 0.04 | 0.02 | 0.08 | 0.08 | 0.08 |
| Sr | 0.012 | 0.012 | — | — | — |

Multilayer assemblies were formed by bonding a core alloy layer (see compositions Alloy A and Alloy C in Table 1 hereinabove, in mass percentages) 480-540 mm in thickness and an AA4045 brazing alloy layer (see compositions 4045-1 and 4045-2 in Table 1 hereinabove, in mass percentages). The brazing alloy was made of AA4045-1 for tests 1 to 5 and of AA4045-2 for test 6. The core alloy was Alloy A for tests 1 to 5 and Alloy C for test 6. The pre-rolling thickness of the multilayer assemblies is detailed in Table 2 hereinafter. The core alloy layer was scalped prior to the bonding step. None of the layers of the assembly was homogenized. The assembly was preheated to a temperature of 480 to 520° C. for a total time from 13 to 27 hours (see Table 2 hereinafter) and a temperature rise time of less than 15 hours, then hot-rolled to a total thickness of 2-3 mm. The reduction in thickness of the first hot-rolling pass is detailed in Table 2 hereinafter. The hot-rolled assemblies made it possible to obtain multilayer strips which then underwent a cold rolling to a total thickness of 0.24 mm. The rolled strips finally underwent an annealing step at a temperature of 250-320° C. for a holding time of less than 12 hours. The final strip was in an H24 temper.

The roughness profile after sawing and before rolling of the AA4045 brazing alloy layers was measured with a perthometer, over a distance of 150 mm, in the direction perpendicular to the saw marks. The start and end of the profile were removed (12.5 mm on either side). The profile was corrected with a second-degree polynomial. The maximum-minimum deviation between peaks and troughs was deduced therefrom. The values of Ra and Rt as defined in the standard NF EN ISO 4287 of December 1998 were then calculated with two Gaussian filters of respective wavelength 0.8 mm and 8 mm over a distance of 125 mm. The roughness Ra (in μm) is the arithmetic mean of the profile. The roughness Rt (in μm) is the total height of the roughness profile. The maximum-minimum deviation, Ra and Rt are reported in Table 2 hereinafter.

The presence of blisters after hot rolling on the surface of the multilayer strip was assessed by observing the strips with the naked eye after hot rolling. A blister corresponds to a swelling of the metal due to an internal delamination at the interface between the brazing layer and the layer below said brazing layer, and is greater than 1 mm in dimension in the rolling direction. The result of this assessment is shown in Table 2 hereinafter.

TABLE 2

| | | Test 1 | Test 2 | Test 3 | Test 4 | Test 5 | Test 6 |
|---|---|---|---|---|---|---|---|
| Roughness | Ra | | | 8-9 | | 8-9 | 2-4 |
| characterization | 0.8 mm filter | | | μm | | μm | μm |
| of brazing layer | Ra | | | 32-44 | | 26-30 | 7-14 |
| after sawing | 8 mm filter | | | μm | | μm | μm |
| and before | Rt | | | 140-210 | | 100-160 | 31-57 |
| bonding | 0.8 mm filter | | | μm | | μm | μm |
| | Rt filter | | | 285-320 | | 200-240 | 49-106 |
| | 8 mm | | | μm | | μm | μm |
| | Max-min | 0.5 | 0.5 | 0.5 | 0.3 | 0.3 | ≤0.3 |
| | deviation over | | | | | | |
| | 150 mm in | | | | | | |
| | perpendicular | | | | | | |
| | direction to | | | | | | |
| | saw marks | | | | | | |
| | (mm) | | | | | | |

| | | | | | | |
|---|---|---|---|---|---|---|
| Preheating of multilayer | Not | Holding | Holding | Holding | Holding | Holding |
| assembly | entered | 21 h | 26 h | 15 h | 15 h | for 9 h |
| Total thickness of multilayer | 555 | 558 | 560 | 555 | 555 | 560 |
| assembly before hot rolling | | | | | | |
| (mm) | | | | | | |
| Thickness reduction of first | 5 | 1 | 2 | 5 | 5 | 3 |
| hot-rolling pass (mm) | | | | | | |
| Presence of blisters after hot | no | yes | yes | no | no | no |
| rolling | | | | | | |

It is noted that there are no blisters when the first hot-rolling pass results in a thickness reduction greater than 2 mm (Tests 1, 4 and 5: 5 mm and Test 6: 3 mm).

The average equivalent diameter of silicon particles of surface area greater than or equal to 0.011 μm² (measured in the L-TC plane) was measured after final annealing according to the method described hereinabove in [0056] for 2 samples: that corresponding to the configuration of Test 1 and for a virtually identical configuration except that the brazing layer was hot-rolled and not sawn before the assembly with the core layer. In the case of the configuration with the sawn brazing layer, the average equivalent diameter of silicon particles of surface area greater than or equal to 0.011 μm² (measured in the L-TC plane) was 1.37 μm. In the case of the configuration with the rolled brazing layer, the average equivalent diameter of silicon particles of surface area greater than or equal to 0.011 μm² (measured in the L-TC plane) was 1.74 μm.

### Example 2

The brazing quality was analyzed using mini-prototypes with different quantities of brazing flux. Two multilayer strip configurations were tested:
strips comprising a layer of AA4045-1 brazing alloy representing 10% in thickness of the total thickness of the strip and a core layer of Alloy A (see Table 1 of example 1) in the H24 temper and 0.24 mm in thickness; and
strips comprising two layers of AA4045-1 brazing alloy, each representing 10% in thickness of the total thickness of the strip, placed on each of the two main faces of a core layer of Alloy B (see Table 1 of example 1) in the H24 temper and 0.4 mm in thickness.

Said strips were obtained according to the following process:
casting an AA4045-1 brazing alloy in the form of a 560 mm thick casting slab;
obtaining a brazing alloy layer by:

either stress-relieving the casting slab for 2 hours at 350° C. then sawing on the two main faces; or hot rolling;
bonding the layers to obtain a multilayer assembly according to the configurations described hereinabove and in Table 4 hereinafter;
preheating the assembly to a temperature of 480 to 520° C. with a total time from 13 to 27 hours and a temperature rise time of less than 15 hours;
hot-rolling the assembly to a total thickness of 2-3 mm, with a reduction in thickness of the first rolling pass of 5 mm, to obtain a multilayer strip;
cold-rolling the strip to a total thickness of 0.24 mm or 0.41 mm;
annealing the strip to a temperature of 250-320° C. for a holding time of less than 10 hours. The final strip was in an H24 temper.

The two configurations are summarized in in Table 4 hereinafter.

TABLE 4

| | | | | Final | |
|---|---|---|---|---|---|
| | | | Cladding | thickness | % brazing |
| | Core | Cladding | layer | (mm) | layer |
| Conf. 1 | Alloy A | 1 face | rolled | 0.24 | 10 |
| Conf. 2 | | | sawn | 0.24 | 10 |
| Conf. 3 | Alloy B | 2 faces | rolled | 0.41 | 10 |
| Conf .4 | | | sawn | 0.41 | 10 |

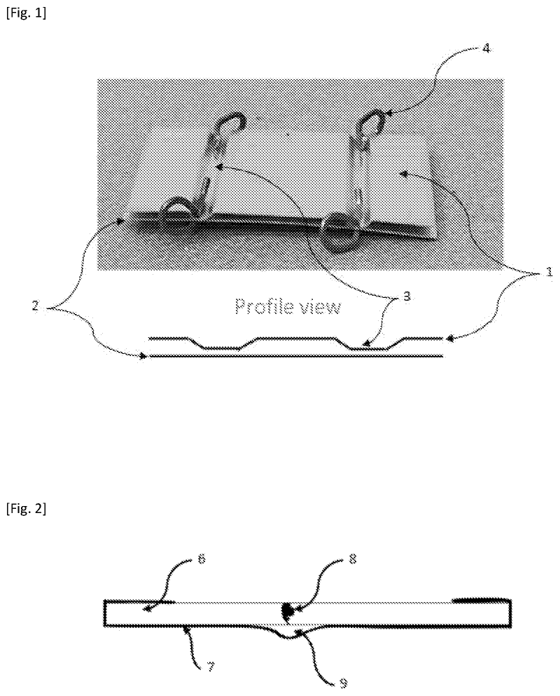

Each configuration was then tested in terms of its brazing quality, according to the following protocol, which makes it possible to simulate brazing stamped components. For this purpose, 50 mm×60 mm foils were cut from the multilayer strips then stamped to add two longitudinal lines as illustrated in FIG. 1. After stamping, the foils were degreased with an acetone solution, then air-dried. Each stamped foil was then fastened to a flat foil having the same composition as the stamped foil, which was previously flattened using a press. The two foils were fastened together using stainless steel pins, as shown in FIG. 1. In FIG. 1, reference 1 corresponds to a stamped foil, reference 2 to a flat foil, reference 3 to two stamped lines and reference 4 to pins. The foils thus assembled were brazed with 5 g/m² of Nocolok® flux in an atmosphere having a quantity of oxygen kept below 25 ppm. The brazing cycle was as follows:
first temperature rise up to approximately 575-580° C. with a rate of approximately 25° C./min;
second temperature rise up to approximately 600° C. with a rate of approximately 2.5° C./min;
holding for 3 minutes at 600° C. +/−2° C.;
cooling to approximately 400° C. with a rate of approximately 25° C./min.

The length of each brazing joint was then measured. For each configuration, three samples were produced. For each sample, two measurements were made at the two stamped longitudinal lines. The configurations tested and the results of the brazing test are shown in Table 5 hereinafter.

The joint length for configurations Conf.1 to Conf.4 is shown in Table 5 hereinafter.

TABLE 5

| | Joint length (%) |
|---|---|
| Conf. 1 | 100 |
| Conf. 2 | 100 |
| Conf. 3 | 100 |
| Conf .4 | 100 |

The brazing for the sawn brazing layers is just as good as for the rolled brazing layers.

### Example 3

Samples Conf.1′ to Conf.4′ were prepared under the same conditions as samples Conf.1 to Conf.4 of example 2 hereinabove, except that the brazing was performed fluxless on A4 formats placed in the upright position in the brazing furnace. The corrosion behavior was determined using the following protocol:
prepare for each configuration a sample of dimensions 126 mm (L direction)×90 mm (TL direction), previously degreased with a white paper towel soaked in acetone;
protect the untested face and the four edges over a width of approximately 0.5 cm with a transparent vinyl adhesive (for example 3M vinyl 764 type);
clean the face to be tested with a paper towel soaked in acetone:
place the samples thus prepared on a rack with a gradient of approximately 60° with respect to the horizontal;
for each sample, perform a SWAAT test (Sea Water Acidified Acetic Test) as per the ASTM G85 A3 standard, particularly comprising an alternation of 30 min spray phases and 1 h30 wet phases at a temperature of 49° C.

The number of perforations was recorded each day for each sample for the entire duration of the test, or 3 or 9 days. The perforations were visible at the back of each sample as they formed blisters in the adhesive applied on the untested face, as illustrated in FIG. 1. In FIG. 2, reference 6 corresponds to the sample; reference 7 corresponds to the adhesive; reference 8 corresponds to a perforation; reference 9 corresponds to a blister formed by a perforation. The results of the monitoring of the number of perforations are shown in Table 6 hereinafter.

TABLE 6

| | Test time | |
|---|---|---|
| | (days) | Number of perforations |
| Conf. 1′ | 3 | 20 |
| Conf. 2′ | 3 | 14-19 |
| Conf. 3′ | 9 | 33 |
| Conf .4′ | 9 | 21 |

The corrosion resistance of the strips comprising a sawn brazing layer is at least as good as that of the strips comprising a rolled brazing alloy layer, and even enhanced after 3 days for thin strips (around 240 μm) and 9 days for thick strips (around 410 μm).

1. A process for manufacturing a multilayer strip or sheet, comprising a core aluminum alloy layer cladded, on one or both main faces, with a brazing aluminum alloy layer, said process comprising:
a. casting a brazing aluminum alloy in the form of a casting slab, having optionally a thickness from 400 to 700 mm, optionally from 500 to 650 mm; optionally a width from 1500 to 2000 mm, optionally from 1600 to 1850 mm; optionally a length from 2500 to 6000 mm, optionally 3000 to 4500 mm;
b. optionally, stress-relieving the casting slab by thermal treatment;
c. sawing the casting slab to obtain brazing alloy layers sawn along a plane parallel with the plane of at least one of the main faces of said casting slab;
d. bonding a core aluminum alloy layer, which can be optionally homogenized, with at least one sawn brazing aluminum alloy layer, to obtain a multilayer assembly;
e. preheating the multilayer assembly, optionally at a temperature from 440 to 540° C., optionally with a holding time at the maximum temperature of less than 30 hours, optionally less than 24 hours, optionally less than 20 hours, optionally with a temperature rise time of less than 24 hours, optionally less than 20 hours, optionally less than 15 hours;
f. hot-rolling the multilayer assembly to obtain a multilayer strip or sheet, the first hot-rolling pass inducing a reduction in thickness of the multilayer assembly greater than or equal to 0.5% of the thickness of the multilayer assembly before said hot-rolling pass; the thickness of the multilayer strip or sheet after all the hot-rolling passes being optionally from 2 to 5.5 mm;
g. optionally, cold-rolling the multilayer strip or sheet, to the desired thickness, the thickness of the strip or sheet after cold rolling being optionally from 0.15 to 3 mm and
h. optionally annealing, optionally at a temperature from 230 to 450° C., optionally with holding at the maximum temperature for 1 minute to 15 hours, optionally for 1 minute to 5 hours.

2. The process for manufacturing a multilayer strip or sheet according to claim 1, wherein the brazing alloy layer(s) represent from 4 to 15%, optionally from 4 and 12% in thickness of the total thickness of the multilayer assembly before any rolling.

3. The process for manufacturing a multilayer strip or sheet according to claim 1, wherein the brazing aluminum alloy casting slab undergoes, prior to the sawing, stress relief at a temperature less than 400° C., optionally less than 380° C., more optionally less than 355° C., optionally less than or equal to 350° C., optionally for a duration less than 24 hours, optionally less than 10 hours and more optionally less than 3 hours.

4. The process for manufacturing a multilayer strip or sheet according to claim 1, wherein the brazing aluminum alloy casting slab does not undergo, prior to the sawing, stress relief.

5. The process for manufacturing a multilayer strip or sheet according to claim 1, wherein the multilayer strip or sheet further comprises at least one intermediate aluminum alloy layer placed between the core aluminum alloy layer and a brazing aluminum alloy layer.

6. The process for manufacturing a multilayer strip or sheet according to claim 1, wherein the core alloy layer undergoes a homogenizing prior to the cladding step, optionally at a temperature from 560 to 630° C., optionally for 10 minutes to 18 hours.

7. The process for manufacturing a multilayer strip or sheet according to claim 1, wherein the core aluminum alloy casting slab does not undergo a homogenizing prior to the cladding.

8. The process for manufacturing a multilayer strip or sheet according to claim 1, wherein the brazing alloy layer is prepared from 4xxx alloy, optionally from an alloy chosen from the AA4045, AA4343, AA4004 and AA4104 alloys, optionally from an alloy optionally 4xxx, AA4045, AA4343, AA4004 and/or AA4104 said alloy comprising a quantity of Zn less than 0.05% by mass.

9. The process for manufacturing a multilayer strip or sheet according claim 1, wherein the brazing alloy layer has, after sawing and before rolling, a surface roughness as defined in the standard NF EN ISO 4287 of December 1998:
Ra less than 14 μm, optionally less than 11 μm, optionally less than 10 μm and optionally greater than 1 μm, optionally greater than 2 μm, measured with a Gaussian filter of 0.8 mm wavelength in a direction perpendicular to saw marks; and/or
Ra less than 50 μm, optionally less than 40 μm, optionally less than 32 μm, optionally less than 20 μm, and optionally greater than 3 μm, optionally greater than 5 μm, measured with a Gaussian filter of 8 mm wavelength in the direction perpendicular to the saw marks; and/or
Rt less than 250 μm, optionally less than 200 μm, optionally less than 180 μm and optionally greater than 25 μm, optionally greater than 30 μm, measured with a Gaussian filter of 0.8 mm wavelength in the direction perpendicular to the saw marks; and/or
Rt less than 400 μm, optionally less than 350 μm, optionally less than 280 μm, and optionally greater than 15 μm, optionally greater than 35 μm, measured with a Gaussian filter of 8 mm wavelength in the direction perpendicular to the saw marks.

10. The process for manufacturing a multilayer strip or sheet according to claim 1 wherein the core alloy layer comprises, in mass percentages:
Si: at most 0.8%, optionally at most 0.6%, optionally at most 0.5%; optionally at most 0.25%;
Fe: at most 0.5%, optionally at most 0.4%, optionally at most 0.3%;
Cu: from 0.20 to 1.2%, optionally from 0.25 to 1.1%, optionally from 0.3 to 1.0%, optionally from 0.5 to 0.8%, optionally from 0.55 to 0.75%;
Mn: from 0.8 to 2.2%, optionally from 0.9 to 2.1%, optionally from 1.0 to 2.0%, more optionally from 1.0 to 1.5%, optionally from 1.25 to 1.45%;
Mg: at most 0.6%, optionally at most 0.35%, optionally at most 0.20%, optionally less than 0.05%;
Zn: at most 0.30%, preferably at most 0.25%, optionally at most 0.20%, optionally less than 0.05%;
Ti: at most 0.30%, optionally at most 0.25%, optionally at most 0.20%, optionally at most 0.14%, optionally at most 0.12%; optionally at least 0.05%;
remainder aluminum and optionally one or more impurities.

11. A strip or sheet, intended for manufacturing brazed heat exchangers, obtained according to the process of claim 1, wherein the brazing aluminum alloy casting slab:
does not undergo, prior to the sawing, homogenizing; and
does not undergo, prior to the sawing, stress relief, or undergoes, prior to the sawing, stress relief at a temperature less than 400° C., optionally less than 380° C., optionally less than 355° C. optionally less than or equal to 350° C., optionally for a duration less than 10 h, optionally less than 5 h;
the strip or sheet at final thickness before brazing having at least one of the brazing layers which is obtained by sawing and which has a silicon particle size of surface area greater than or equal to 0.011 μm² (measured in the L-TC plane) such that the average equivalent diameter of these particles is less than 1.6 μm, optionally less than 1.5 μm, optionally less than 1.4 μm.

12. A heat exchanger made at least partially from a strip or sheet obtained according to the process according to claim 1.

13. A product comprising a strip or sheet according to claim 11, for manufacturing a heat exchanger, said strip or sheet having an enhanced corrosion resistance without degrading the mechanical strength or brazability compared to a strip or sheet having an identical configuration but comprising at least one brazing layer obtained by rolling.
